(19) United States
(12) Patent Application Publication
(10) Pub. No.: US 2024/0072380 A1
(43) Pub. Date: Feb. 29, 2024

(54) BUSBAR MODULE

(71) Applicant: Yazaki Corporation, Tokyo (JP)

(72) Inventor: Kimitoshi Makino, Shizuoka (JP)

(21) Appl. No.: 18/457,706

(22) Filed: Aug. 29, 2023

(30) Foreign Application Priority Data
Aug. 30, 2022 (JP) 2022-136535

(51) Int. Cl. H01M 50/507; H01M 50/519

(52) U.S. Cl. CPC H01M 50/507; H01M 50/519

(57) ABSTRACT

A busbar module includes a first busbar group, a second busbar group, a flexible printed wiring board, and a case made of resin. The flexible printed wiring board includes a base end and a main body. The flexible printed wiring board includes a first slit portion and a second slit portion. The main body is divided by the second slit portion into two regions, a first region and a second region. The case includes a first case portion and a second case portion. The first case portion is configured so that the first region and the first cover cover the first busbar group. The second case portion is configured so that the second region and the second cover cover the second busbar group.

### CROSS-REFERENCE TO RELATED APPLICATION(S)

The present application claims priority to and incorporates by reference the entire contents of Japanese Patent Application No. 2022-136535 filed in Japan on Aug. 30, 2022.

### BACKGROUND OF THE INVENTION

### 1. Field of the Invention

The present invention relates to busbar modules.

### 2. Description of the Related Art

Battery wiring modules have conventionally been available. Japanese Patent Application Laid-open No. 2018-18612 discloses a battery wiring module that includes a wiring pattern formed on one surface side of a board main body portion and configured as a signal transmission path and a guard pattern formed in the vicinity of the wiring pattern on the one surface side of the board main body portion and kept at a predetermined reference potential while being insulated from the wiring pattern. The battery wiring module in Japanese Patent Application Laid-open No. 2018-18612 covers the entire top surface of an electric cell group.

It is desired to reduce the area exclusive to a busbar module in plan view. A smaller area exclusive to a busbar module reduces interference with other components and leads to a lower profile of the battery pack.

### SUMMARY OF THE INVENTION

An object of the present invention is to provide a busbar module that can reduce the exclusive area.

In order to achieve the above mentioned object, a busbar module according to one aspect of the present invention includes a first busbar group including a plurality of busbars aligned in a first direction; a second busbar group including a plurality of busbars aligned in the first direction, the second busbar group being arranged in parallel with the first busbar group; a flexible printed wiring board including a plurality of first conductors and a plurality of second conductors, the first conductors being connected to the busbars of the first busbar group, the second conductors being connected to the busbars of the second busbar group; and a case made of resin, wherein the flexible printed wiring board includes a base end and a main body, the base end being one end in the first direction and being connected to an external device, the main body extending from the base end to another end in the first direction, the flexible printed wiring board includes a slit having a T-shape in plan view, the slit includes a first slit portion and a second slit portion, the first slit portion being disposed at the base end and extending in a second direction orthogonal to the first direction, the second slit portion lying across the main body from the first slit portion in the first direction, the main body is divided by the second slit portion into two regions, a first region and a second region, the first region including the first conductors, the second region including the second conductors, the case includes a first case portion and a second case portion, the first case portion includes a first accommodator, a first cover, and a first hinge, the first accommodator accommodating the first busbar group, the first cover supporting the first region, the first hinge being flexible and linking the first accommodator to the first cover, the first case portion being configured so that bending the first hinge allows the first region and the first cover to cover the first busbar group, and the second case portion includes a second accommodator, a second cover, and a second hinge, the second accommodator accommodating the second busbar group, the second cover supporting the second region, the second hinge being flexible and linking the second accommodator to the second cover, the second case portion being configured so that bending the second hinge allows the second region and the second cover to cover the second busbar group.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a busbar module and a battery module according to an embodiment;

FIG. 2 is a plan view of the busbar module according to the embodiment;

FIG. 3 is a plan view of a flexible printed wiring board according to the embodiment;

FIG. 4 is a perspective view of a case according to the embodiment;

FIG. 5 is a perspective view of the busbar module according to the embodiment;

FIG. 6 is a perspective view of the busbar module placed on the battery module;

FIG. 7 is a diagram describing a cover folding-back step;

FIG. 8 is a side view of the busbar module assembled to the battery module; and

FIG. 9 is a perspective view of the busbar module assembled to the battery module.

### DETAILED DESCRIPTION OF THE PREFERRED EMBODIMENTS

Busbar modules according to embodiments of the present invention will be described in detail below with reference to the drawings. Note that these embodiments should not be construed to limit this invention. Constituents in the following embodiments include constituents that can be readily conceived by those skilled in the art or that are substantially the same.

### Embodiments

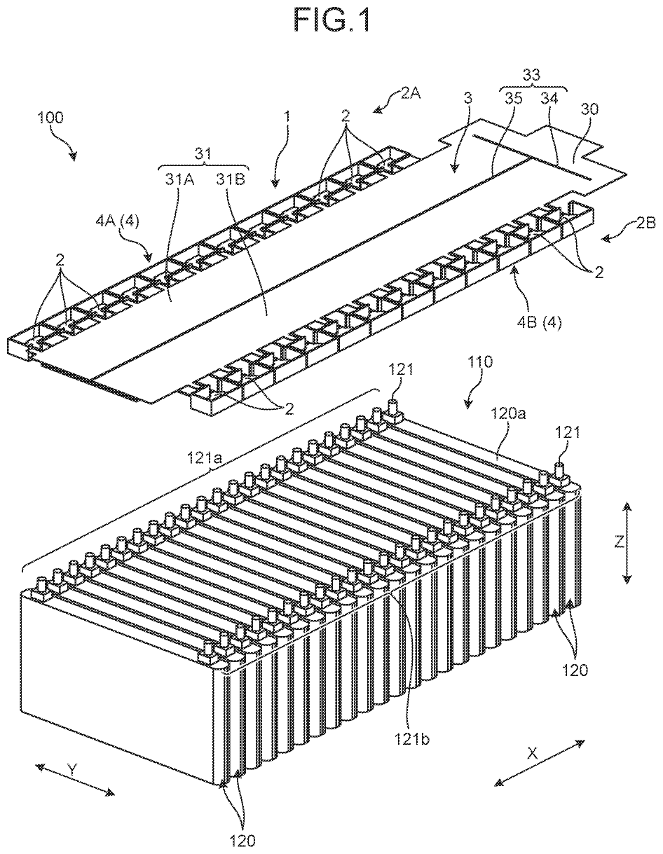

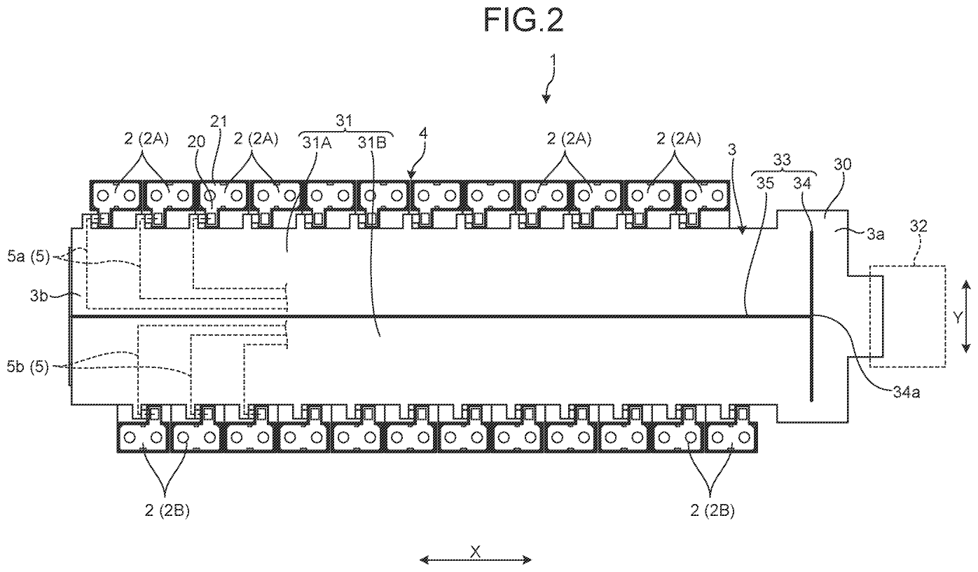

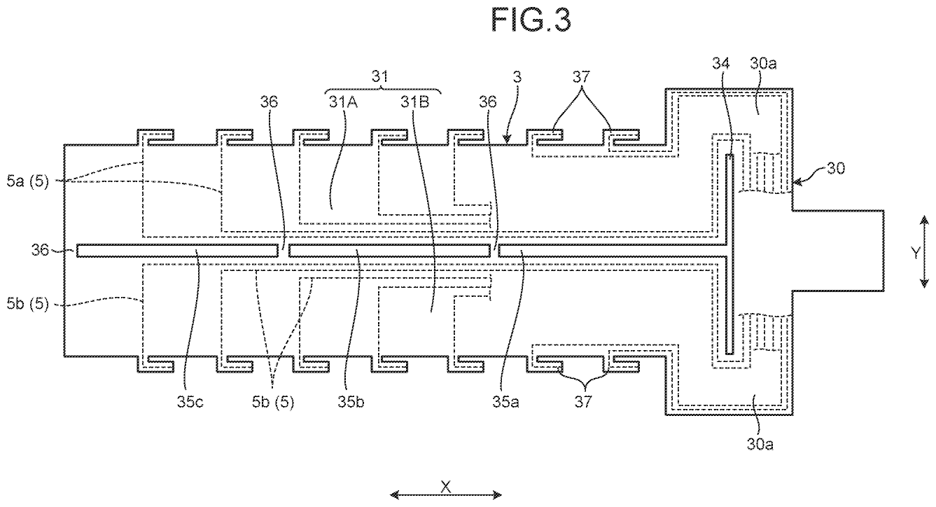

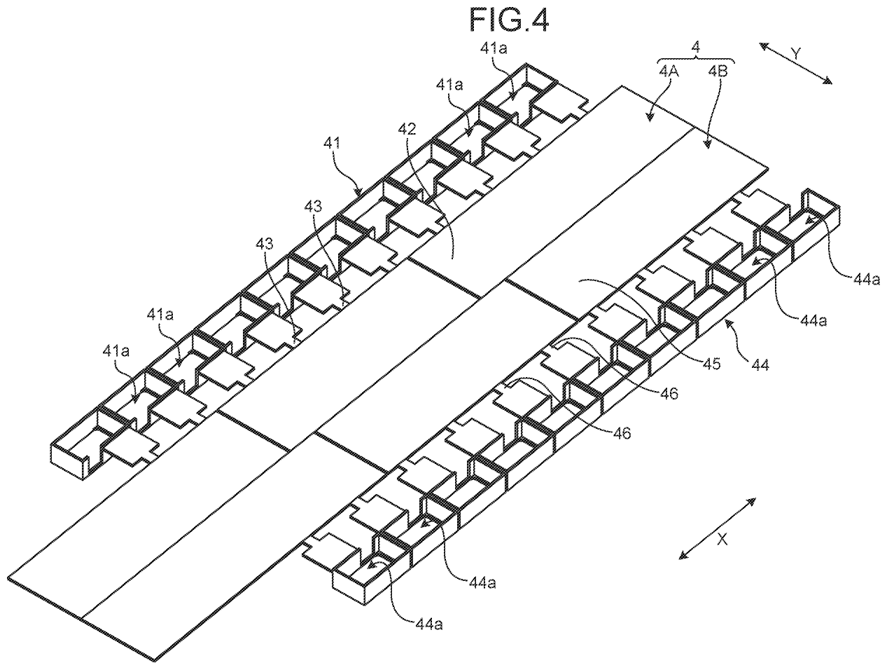

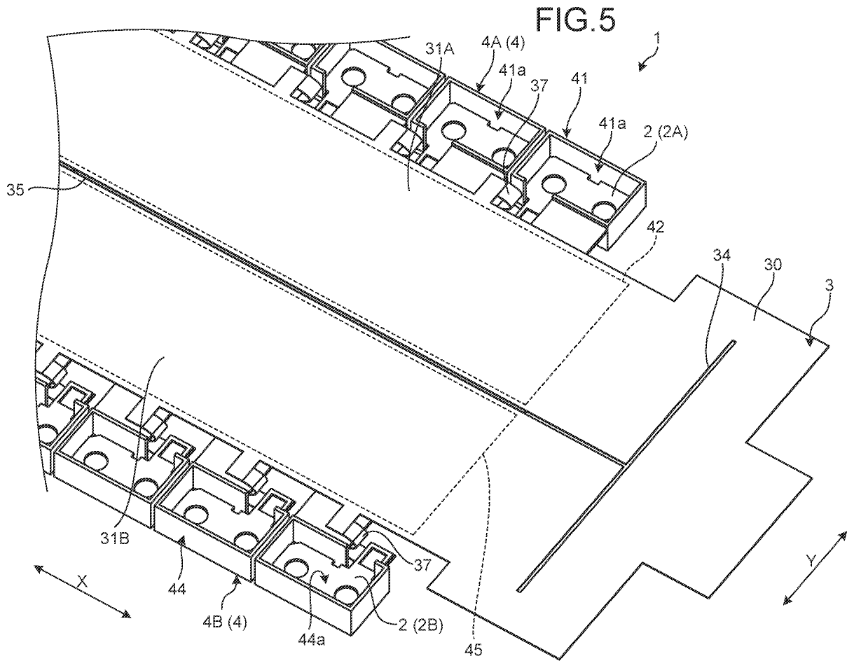

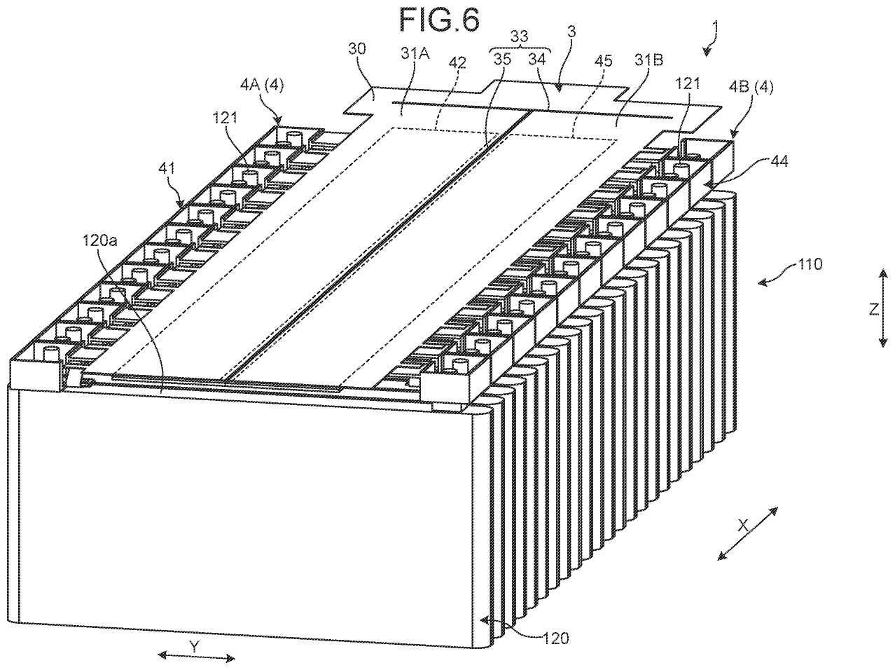

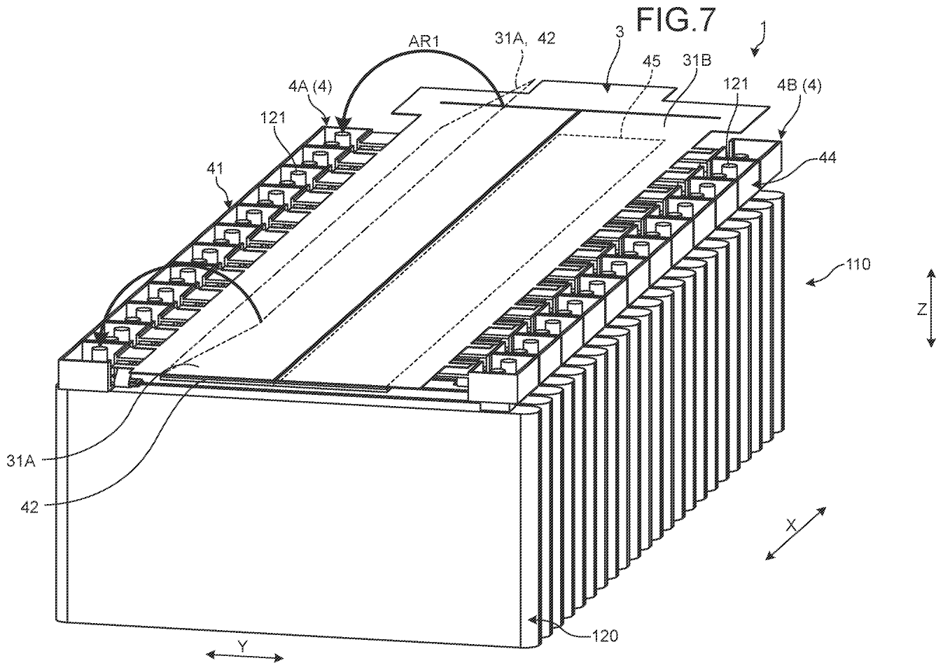

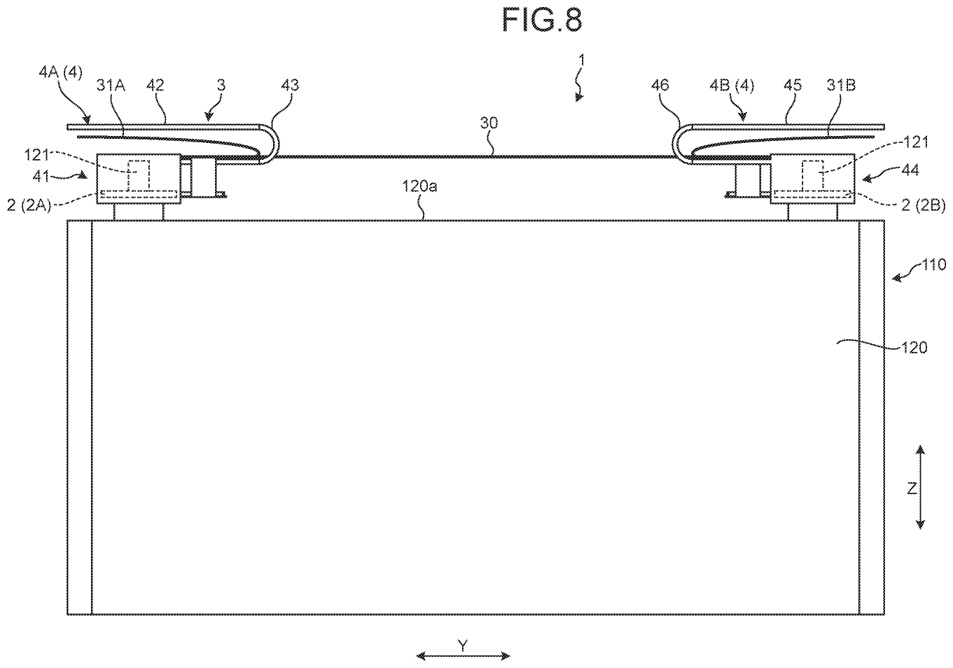

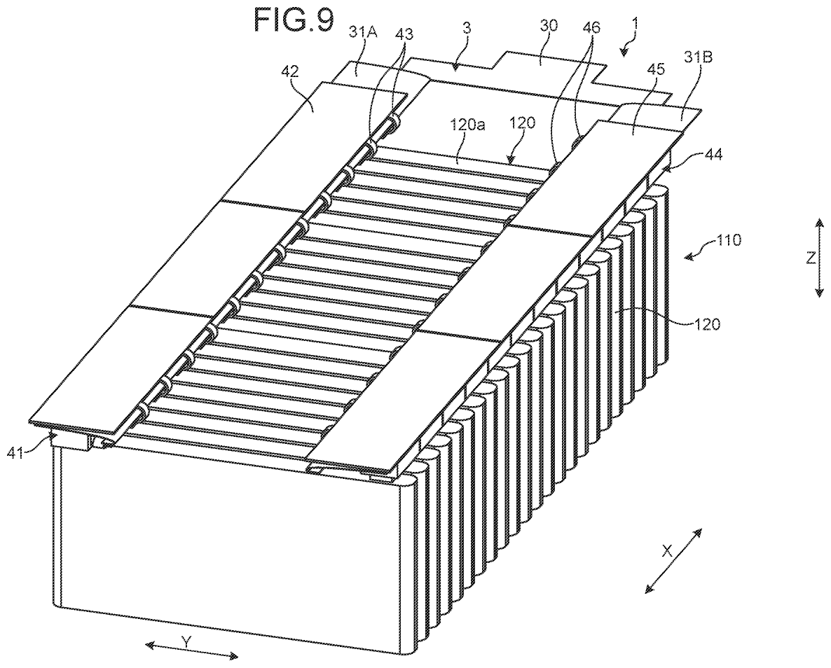

An embodiment will be described with reference to FIGS. 1 to 9. This embodiment relates to a busbar module. FIG. 1 is a perspective view of a busbar module and a battery module according to the embodiment, FIG. 2 is a plan view of the busbar module according to the embodiment, FIG. 3 is a plan view of a flexible printed wiring board according to the embodiment, FIG. 4 is a perspective view of a case according to the embodiment, FIG. 5 is a perspective view of the busbar module according to the embodiment, FIG. 6 is a perspective view of the busbar module placed on the battery module, FIG. 7 is a diagram describing a cover folding-back step, FIG. 8 is a side view of the busbar module assembled to the battery module, and FIG. 9 is a perspective view of the busbar module assembled to the battery module.

As illustrated in FIG. 1, a busbar module 1 of this embodiment is assembled to a battery module 110. The busbar module 1 and the battery module 110 composes a battery pack 100. The battery pack 100 is installed as a power source in a vehicle, such as an electric vehicle (EV), a hybrid electric vehicle (HEV), and a plug-in hybrid electric vehicle (PHEV). The battery pack 100 may include a plurality of the busbar modules 1 and a plurality of the battery modules 110.

The battery module 110 includes a plurality of battery cells 120. The exemplified battery cells 120 have a cuboid shape. On a first surface 120a of each of the battery cells 120, two electrodes 121 are disposed. The first surface 120a has a substantially rectangular shape.

The battery cells 120 are arranged in a first direction X. To be more specific, the battery cells 120 are arranged so that long sides of the first surfaces 120a face long sides of other adjacent first surfaces 120a in the first direction X. In the following description, the direction orthogonal to the first direction X on the first surfaces 120a is referred to as “second direction Y”. The second direction Y coincides with the lengthwise direction of the first surfaces 120a. The direction orthogonal to both the first direction X and the second direction Y is referred to as “third direction Z”. The third direction Z coincides with the height direction of the battery cells 120. The first surfaces 120a are orthogonal to the third direction Z. The battery pack 100 is installed in a vehicle so that, for example, the first surfaces 120a face upward in the vertical direction of the vehicle.

The two electrodes 121 on each first surface 120a are aligned in the second direction Y. Of the two electrodes 121 on the first surface 120a, one is a positive electrode and the other is a negative electrode. The aggregate of the electrodes 121 disposed on ends of the first surfaces 120a on one side in the lengthwise direction is referred to as “first electrode group 121a”. The aggregate of the electrodes 121 disposed on ends of the first surfaces 120a on the other side in the lengthwise direction is referred to as “second electrode group 121b”. In the battery module 110 of this embodiment, the positive electrodes and the negative electrodes are alternately aligned in the first electrode group 121a. In the second electrode group 121b, the positive electrodes and the negative electrodes are alternately aligned. The busbar module 1 of this embodiment connects the battery cells 120 in series.

The busbar module 1 of this embodiment includes a plurality of busbars 2, a flexible printed wiring board 3, and a case 4. The busbars 2 are formed from a plate of conductive metal, such as copper and aluminum. As illustrated in FIG. 2, each of the busbars 2 includes a connection portion 20 and a terminal portion 21. The connection portion 20 is a portion connected to a voltage detecting line of the flexible printed wiring board 3. The terminal portion 21 is a portion connected to the electrodes 121 of the battery cell 120. The terminal portion 21 includes two through-holes into which the electrodes 121 are inserted. The terminal portion 21 is, for example, welded to the electrodes 121. Note that the terminal portion 21 may be fastened to the electrodes 121 by tightening a nut around the electrodes 121.

The busbar module 1 includes a first busbar group 2A and a second busbar group 2B. The first busbar group 2A and the second busbar group 2B each include a plurality of the busbars 2 aligned in the first direction X. The busbars 2 of the first busbar group 2A are fixed to the first electrode group 121a of the battery module 110. The busbars 2 of the second busbar group 2B are fixed to the second electrode group 121b. The first busbar group 2A and the second busbar group 2B are arranged in parallel.

The flexible printed wiring board 3 is a flexible printed circuit board. The flexible printed wiring board 3 includes a resin layer formed from insulating synthetic resin and a plurality of conductors. The conductors are a conductor layer sandwiched between two resin layers and are, for example, metal foil, such as copper foil.

The flexible printed wiring board 3 of this embodiment includes a base end 30 and a main body 31. The base end 30 and the main body 31 are one piece. The base end 30 is one end 3a of the flexible printed wiring board 3 in the first direction X. The base end 30 is a portion connected to an external device. The external device is typically a monitoring device monitoring the battery pack 100. A connector 32 connected to the external device may be disposed at the base end 30.

The main body 31 extends from the base end 30 to the other end 3b of the flexible printed wiring board 3 in the first direction X. The flexible printed wiring board 3 includes a slit 33 having a T-shape in plan view. The slit 33 includes a first slit portion 34 and a second slit portion 35. The first slit portion 34 is disposed at the base end 30 and extends in the second direction Y. The exemplified first slit portion 34 extends from the center of the base end 30 toward both sides in the second direction Y.

The second slit portion 35 lies across the main body 31 from the first slit portion 34 in the first direction X. The exemplified second slit portion 35 is linked to a center 34a of the first slit portion 34. The main body 31 is divided by the second slit portion 35 into two regions, a first region 31A and a second region 31B. The first region 31A and the second region 31B have a rectangular shape.

Conductors 5 of the flexible printed wiring board 3 include a plurality of first conductors 5a and a plurality of second conductors 5b. The conductors 5 are the voltage detecting lines for detecting voltage of the battery cells 120. The first conductors 5a are the conductors 5 connected to the busbars 2 of the first busbar group 2A. One end of each of the first conductors 5a is connected to the corresponding busbar 2 of the first busbar group 2A. The other end of the first conductor 5a is connected to, for example, a terminal of the connector 32. The first conductors 5a are routed in the first region 31A.

The second conductors 5b are the conductors 5 connected to the busbars 2 of the second busbar group 2B. One end of each of the second conductors 5b is connected to the corresponding busbar 2 of the second busbar group 2B. The other end of the second conductor 5b is connected to, for example, a terminal of the connector 32. The second conductors 5b are routed in the second region 31B.

FIG. 3 illustrates the flexible printed wiring board 3 as a separate piece before connected to the busbars 2. The separate flexible printed wiring board 3 includes a plurality of linking portions 36 linking the first region 31A and the second region 31B to each other. By cutting the linking portions 36, the main body 31 is divided into the first region 31A and the second region 31B. The exemplified flexible printed wiring board 3 includes three linking portions 36. The separate flexible printed wiring board 3 includes three through-holes 35a, 35b, and 35c extending in the first direction X. The through-holes 35a, 35b, and 35c are located at the boundary between the first region 31A and the second region 31B. Cutting the three linking portions 36 links the through-holes 35a, 35b, and 35c to each other, composing the second slit portion 35.

The first region 31A and the second region 31B include a plurality of branches 37. The branches 37 protrude in the second direction Y. The branches 37 of the first region 31A protrude toward a side opposite to the second region 31B. The branches 37 of the second region 31B protrude toward a side opposite to the first region 31A. The branches 37 have an L-shape in plan view. The conductors 5 are routed in the respective branches 37. The branches 37 are fixed to the busbars 2 by welding or the like. The conductors 5 routed in the branches 37 are electrically connected to the busbars 2.

The base end 30 includes two protrusions 30a. One of the protrusions 30a protrudes in the second direction Y relative to the first region 31A of the main body 31. The other protrusion 30a protrudes in the second direction Y relative to the second region 31B of the main body 31. The first conductors 5a and the second conductors 5b are routed in the protrusions 30a while bypassing the first slit portion 34 in the base end 30.

A step of connecting the busbars 2 to the branches 37 may be performed with the flexible printed wiring board 3 having the linking portions 36. A step of placing the flexible printed wiring board 3 on the case 4 and a step of accommodating the busbars 2 in the case 4 may be performed with the flexible printed wiring board 3 having the linking portions 36.

As illustrated in FIG. 4, the case 4 includes a first case portion 4A and a second case portion 4B. The exemplified first case portion 4A and second case portion 4B are separate members. The first case portion 4A corresponds to the first busbar group 2A and the first region 31A, and the second case portion 4B corresponds to the second busbar group 2B and the second region 31B. The first case portion 4A and the second case portion 4B are, for example, molded from insulating synthetic resin.

The first case portion 4A includes a first accommodator 41, a first cover 42, and a flexible first hinge 43. The first accommodator 41 accommodates the busbars 2 of the first busbar group 2A. The first accommodator 41 has a substantially rectangular shape in plan view. The first accommodator 41 includes a plurality of accommodating chambers 41a. The accommodating chambers 41a are arranged in the first direction X. Each of the accommodating chambers 41a accommodates one of the busbars 2.

The first cover 42 is a portion supporting the first region 31A of the flexible printed wiring board 3. The first cover 42 extends in the first direction X. The first cover 42 has a rectangular shape in plan view. The first cover 42 is disposed, aligned with the first accommodator 41 in the second direction Y.

The first hinge 43 links the first accommodator 41 to the first cover 42. The first case portion 4A includes a plurality of the first hinges 43. The exemplified first case portion 4A includes one first hinge 43 for each accommodating chamber 41a. The first case portion 4A is configured so that bending the first hinges 43 allows the first cover 42 to overlap with the first accommodator 41.

The second case portion 4B includes a second accommodator 44, a second cover 45, and a flexible second hinge 46. The second accommodator 44 accommodates the busbars 2 of the second busbar group 2B. The second accommodator 44 has a substantially rectangular shape in plan view. The second accommodator 44 includes a plurality of accommodating chambers 44a. The accommodating chambers 44a are arranged in the first direction X. Each of the accommodating chambers 44a accommodates one of the busbars 2.

The second cover 45 is a portion supporting the second region 31B of the flexible printed wiring board 3. The second cover 45 extends in the first direction X. The second cover 45 has a rectangular shape in plan view. The second cover 45 is disposed, aligned with the second accommodator 44 in the second direction Y.

The second hinge 46 links the second accommodator 44 to the second cover 45. The second case portion 4B includes a plurality of the second hinges 46. The exemplified second case portion 4B includes one second hinge 46 for each accommodating chamber 44a. The second case portion 4B is configured so that bending the second hinges 46 allows the second cover 45 to overlap with the second accommodator 44.

The flexible printed wiring board 3 to which the busbars 2 are attached is placed on the case 4 and assembled to the case 4. As illustrated in FIG. 5, the first region 31A of the flexible printed wiring board 3 is placed on the first cover 42. The busbars 2 of the first busbar group 2A are inserted into the accommodating chambers 41a of the first accommodator 41 and held by the accommodating chambers 41a. The busbars 2 are accommodated in the accommodating chambers 41a with the branches 37 bent into an S-shape. The first region 31A may be fixed to the first cover 42. For example, the first cover 42 may be provided with a claw locking the first region 31A.

The second region 31B of the flexible printed wiring board 3 is placed on the second cover 45. The busbars 2 of the second busbar group 2B are inserted into the accommodating chambers 44a of the second accommodator 44 and held by the accommodating chambers 44a. The busbars 2 are accommodated in the accommodating chambers 44a with the branches 37 bent into an S-shape. The second region 31B may be fixed to the second cover 45. For example, the second cover 45 may be provided with a claw locking the second region 31B.

The linking portions 36 of the flexible printed wiring board 3 may be cut after the flexible printed wiring board 3 is assembled to the case 4 or before the flexible printed wiring board 3 is assembled to the case 4. As illustrated in FIG. 5, the second slit portion 35 is located at the boundary between the first cover 42 and the second cover 45.

FIG. 6 illustrates the busbar module 1 placed on the battery module 110. The electrodes 121 of the battery cells 120 are inserted into the through-holes of the busbars 2 and accommodated in the accommodating chambers 41a and 44a. The first surfaces 120a of the battery cells 120 are covered by the first cover 42 and the second cover 45 of the case 4. The first cover 42 is covered by the first region 31A of the flexible printed wiring board 3, and the second cover 45 is covered by the second region 31B of the flexible printed wiring board 3. The busbars 2 are fixed to the electrodes 121 by welding, for example.

After the busbars 2 have been fixed to the electrodes 121, the first region 31A and the second region 31B of the flexible printed wiring board 3 are folded back. As illustrated with arrows AR1 in FIG. 7, the first region 31A and the first cover 42 are folded back so as to cover the first accommodator 41. Lifting the first cover 42 bends the first hinges 43 of the first case portion 4A. In other words, the first cover 42 rotates about the first hinges 43 toward the first accommodator 41. The first region 31A is folded back while being supported by the first cover 42 and covers the first accommodator 41. The first cover 42 preferably includes an engaging portion engaging with the first accommodator 41.

The second region 31B and the second cover 45 are folded back so as to cover the second accommodator 44. The second cover 45 rotates about the second hinges 46 toward the second accommodator 44. The second region 31B is folded back while being supported by the second cover 45 and covers the second accommodator 44. The second cover 45 preferably includes an engaging portion engaging with the second accommodator 44.

FIGS. 8 and 9 illustrate the busbar module 1 that has been assembled to the battery module 110. The first region 31A of the flexible printed wiring board 3 and the first cover 42 cover the first accommodator 41. As illustrated in FIG. 8, the busbars 2 of the first busbar group 2A and the electrodes 121 are hidden, covered by the first region 31A and the first cover 42. The second region 31B of the flexible printed wiring board 3 and the second cover 45 cover the second accommodator 44. As illustrated in FIG. 8, the busbars 2 of the second busbar group 2B and the electrodes 121 are hidden, covered by the second region 31B and the second cover 45.

As illustrated in FIG. 8, the first hinges 43 are curved to be substantially U-shaped. This defines an appropriate space between the first accommodator 41 and the first cover 42. Thus, the first region 31A is prevented from being bent excessively, which protects the conductors 5. Similarly, the second hinges 46 define an appropriate space between the second accommodator 44 and the second cover 45, which protects the conductors 5 in the second region 31B.

As illustrated in FIG. 9, the base end 30 of the flexible printed wiring board 3 is located outside the battery module 110 in the first direction X. That is, the busbar module 1 of this embodiment can free a space above the battery module 110 from one end to the other end of the battery module 110 in the first direction X. In other words, the busbar module 1 of this embodiment can minimize the exclusive area covering the battery module 110.

The first cover 42 and the second cover 45 are folded back to free the space above the first surfaces 120a of the battery cells 120. In other words, the space between the first hinges 43 and the second hinges 46 is freed upward. Thus, if a member, such as a smoke exhausting duct, is disposed on the first surfaces 120a, the busbar module 1 of this embodiment can be assembled to the battery module 110 without interfering with the member.

Furthermore, the busbar module 1 of this embodiment can minimize the exclusive area in plan view. If a plurality of the conductors 5 are routed in the main body 31, the required width of the main body 31 is determined depending on the number of the conductors 5. In the busbar module 1 of this embodiment, overlapping the first region 31A and the second region 31B with the accommodators 41 and 44 can reduce the area exclusive to the busbar module 1 while ensuring the required width of the main body 31.

The shape of the flexible printed wiring board 3 and its assembly method in this embodiment can provide high yield of FPCs and easy manufacturing, such as component mounting. Thus, the busbar module 1 of this embodiment can improve manufacturing efficiency and reduce cost.

As described above, the busbar module 1 of this embodiment includes the first busbar group 2A, the second busbar group 2B, the flexible printed wiring board 3, and the case 4 made of resin. The first busbar group 2A includes the busbars 2 aligned in the first direction X. The second busbar group 2B includes the busbars 2 aligned in the first direction X and is arranged in parallel with the first busbar group 2A. The flexible printed wiring board 3 includes the first conductors 5a connected to the busbars 2 of the first busbar group 2A and the second conductors 5b connected to the busbars 2 of the second busbar group 2B.

The flexible printed wiring board 3 includes the base end 30 and the main body 31. The base end 30 is the one end 3a of the flexible printed wiring board 3 in the first direction X and is connected to the external device. The main body 31 extends from the base end 30 to the other end 3b of the flexible printed wiring board 3 in the first direction X. The flexible printed wiring board 3 includes a slit 33 having a T-shape in plan view. The slit 33 includes the first slit portion 34 and the second slit portion 35. The first slit portion 34 is disposed at the base end 30 and extends in the second direction Y orthogonal to the first direction X. The second slit portion 35 lies across the main body 31 from the first slit portion 34 in the first direction X.

The main body 31 of the flexible printed wiring board 3 is divided by the second slit portion 35 into two regions, the first region 31A and the second region 31B. The first region 31A is a region including the first conductors 5a. The second region 31B is a region including the second conductors 5b.

The case 4 includes the first case portion 4A and the second case portion 4B. The first case portion 4A includes the first accommodator 41, the first cover 42, and the first hinges 43. The first accommodator 41 accommodates the first busbar group 2A. The first cover 42 supports the first region 31A of the flexible printed wiring board 3. The first hinges 43 link the first accommodator 41 to the first cover 42 and are flexible. The first case portion 4A is configured so that bending the first hinges 43 allows the first region 31A and the first cover 42 to cover the first busbar group 2A.

The second case portion 4B includes the second accommodator 44, the second cover 45, and the second hinges 46. The second accommodator 44 accommodates the second busbar group 2B. The second cover 45 supports the second region 31B of the flexible printed wiring board 3. The second hinges 46 link the second accommodator 44 to the second cover 45 and are flexible. The second case portion 4B is configured so that bending the second hinges 46 allows the second region 31B and the second cover 45 to cover the second busbar group 2B. The busbar module 1 of this embodiment can reduce the exclusive area relative to the battery module 110 and free a space above the battery cells 120.

The base end 30 of this embodiment includes the protrusions 30a protruding in the second direction Y relative to the main body 31. In the base end 30, the first conductors 5a and the second conductors 5b are routed in the protrusions 30a while bypassing the first slit portion 34. This configuration enables the flexible printed wiring board 3 to ensure a routing path of the conductors 5 while being capable of being folded back.

As illustrated in FIGS. 8 and 9, the busbar module 1 assembled to the battery module 110 includes the first busbar group 2A, the second busbar group 2B, the flexible printed wiring board 3, and the case 4 made of resin. The flexible printed wiring board 3 includes the base end 30 and the main body 31. The main body 31 is divided into the first region 31A connected to the first busbar group 2A and the second region 31B connected to the second busbar group 2B.

The case 4 includes the first case portion 4A and the second case portion 4B. The first case portion 4A accommodates the first busbar group 2A and the first region 31A while the first region 31A is folded back so as to cover the first busbar group 2A. The second case portion 4B accommodates the second busbar group 2B and the second region 31B while the second region 31B is folded back so as to cover the second busbar group 2B. The busbar module 1 of this embodiment can reduce the exclusive area relative to the battery module 110 and free a space above the battery cells 120.

Note that, in the flexible printed wiring board 3 before assembled to the case 4, the first slit portion 34 may be provided with a linking portion similar to the linking portions 36. The linking portion of the first slit portion 34 is cut after the flexible printed wiring board 3 is assembled to the case 4.

In the case 4, the first case portion 4A and the second case portion 4B may be linked to each other. For example, the case 4 may include a linking portion linking the first case portion 4A to the second case portion 4B. In this case, the case 4 may have a U-shape or a rectangular frame shape with the first cover 42 and the second cover 45 folded back, in plan view.

The flexible printed wiring board 3 may include a plurality of the conductor layers. For example, in the first region 31A and the base end 30, the first conductors 5a may be disposed, divided between the layers. For example, in the second region 31B and the base end 30, the second conductors 5b may be disposed, divided between the layers.

The content disclosed in the above embodiments can be combined and implemented as appropriate.

In the busbar module according to the present embodiments, the first case portion is configured so that bending the first hinge allows the first region of the flexible printed wiring board and the first cover to cover the first busbar group. The second case portion is configured so that bending the second hinge allows the second region of the flexible printed wiring board and the second cover to cover the second busbar group. The busbar module according to the present invention has the effect of reducing the exclusive area.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A busbar module comprising:
a first busbar group including a plurality of busbars aligned in a first direction;
a second busbar group including a plurality of busbars aligned in the first direction, the second busbar group being arranged in parallel with the first busbar group;
a flexible printed wiring board including a plurality of first conductors and a plurality of second conductors, the first conductors being connected to the busbars of the first busbar group, the second conductors being connected to the busbars of the second busbar group; and
a case made of resin, wherein
the flexible printed wiring board includes a base end and a main body, the base end being one end in the first direction and being connected to an external device, the main body extending from the base end to another end in the first direction,
the flexible printed wiring board includes a slit having a T-shape in plan view,
the slit includes a first slit portion and a second slit portion, the first slit portion being disposed at the base end and extending in a second direction orthogonal to the first direction, the second slit portion lying across the main body from the first slit portion in the first direction,
the main body is divided by the second slit portion into two regions, a first region and a second region, the first region including the first conductors, the second region including the second conductors,
the case includes a first case portion and a second case portion,
the first case portion includes a first accommodator, a first cover, and a first hinge, the first accommodator accommodating the first busbar group, the first cover supporting the first region, the first hinge being flexible and linking the first accommodator to the first cover, the first case portion being configured so that bending the first hinge allows the first region and the first cover to cover the first busbar group, and
the second case portion includes a second accommodator, a second cover, and a second hinge, the second accommodator accommodating the second busbar group, the second cover supporting the second region, the second hinge being flexible and linking the second accommodator to the second cover, the second case portion being configured so that bending the second hinge allows the second region and the second cover to cover the second busbar group.

2. The busbar module according to claim 1, wherein
the base end includes a protrusion protruding in the second direction relative to the main body, and
in the base end, the first conductors and the second conductors are routed in the protrusion while bypassing the first slit portion.

3. A busbar module comprising:
a first busbar group including a plurality of busbars aligned in a first direction;
a second busbar group including a plurality of busbars aligned in the first direction, the second busbar group being arranged in parallel with the first busbar group;
a flexible printed wiring board including a plurality of first conductors and a plurality of second conductors, the first conductors being connected to the busbars of the first busbar group, the second conductors being connected to the busbars of the second busbar group; and
a case made of resin, wherein
the flexible printed wiring board includes a base end and a main body, the base end being one end in the first direction and being connected to an external device, the main body extending from the base end to another end in the first direction,
the main body is divided into a first region and a second region, the first region being connected to the first busbar group, the second region being connected to the second busbar group,
the case includes a first case portion and a second case portion,
the first case portion accommodates the first busbar group and the first region while the first region is folded back so as to cover the first busbar group, and
the second case portion accommodates the second busbar group and the second region while the second region is folded back so as to cover the second busbar group.
